(19) United States
(12) Patent Application Publication
(10) Pub. No.: US 2025/0102045 A1
(43) Pub. Date: Mar. 27, 2025

(54) Fixing device and method for fixing a belt connector to a belt band end of a transport belt

(71) Applicant: MATO GMBH & CO. KG, Mühlheim am Main (DE)

(72) Inventors: Michael Friess, Hanau-Steinheim (DE); Thomas Wilk, Mühlheim a.M. (DE)

(73) Assignee: MATO GMBH & CO. KG, Mühlheim am Main (DE)

(21) Appl. No.: 18/728,721

(22) PCT Filed: Jan. 3, 2023
(86) PCT No.: PCT/EP2023/050080

§ 371 Date: Jul. 12, 2024

(30) Foreign Application Priority Data
Jan. 13, 2022 (EP) 22151356.7

(51) Int. Cl. F16G 3/00; F16G 3/04; F16G 3/16

(52) U.S. Cl. CPC F16G 3/003; F16G 3/04; F16G 3/16

(57) ABSTRACT

A fixing device for fixing belt connectors to a belt band end of a transport belt by means of fixing cramps and a method for fixing a belt connector to a belt band end of a transport belt using the fixing device is disclosed. The fixing device has a press-in die for pressing in the fixing cramp, a forming die having a bending-over structure for bending over free ends of the fixing cramp and a pressing die which is opposite the press-in die for pressing the bent-over free ends of the fixing cramp.

### CROSS-REFERENCE TO RELATED APPLICATIONS

This is a United States national stage application from International (PCT) Application No. PCT/EP2023/050080 filed on Jan. 3, 2023, which claims the priority of European Application No. EP 22 151 356.7 filed on Jan. 13, 2022, the entire contents of which are incorporated herein by reference.

### FIELD OF THE INVENTION

The present invention relates to a fixing device for fixing belt connectors to a belt band end of a transport belt by means of fixing cramps. The invention further relates to a method for fixing a belt connector to a belt band end of a transport belt using the fixing device according to the invention.

### BACKGROUND OF THE INVENTION AND RELATED ART

It is known from the prior art to use belt connectors for the purpose of producing a continuous connection and/or connecting transport belts. Such belt connectors have at least one connector element having two opposite legs, wherein the legs are generally connected to each other via a curved portion and the belt band end is arranged between the two legs. Generally, the two legs have through-holes for fixing means, for example, for one or more fixing cramps, wherein, in order to fix the connector element to the belt band end, the fixing cramp is driven through the through-holes of the two legs so as to penetrate the belt band end which is arranged between the two legs and the projecting free ends of the fixing cramp are bent over, wherein the action of bending over is carried out in such a manner that the two free ends of the cramp are bent over in the end position thereof as far as possible and preferably move into abutment against the leg at which they project. Accordingly, these free ends are bent over as far as possible, preferably by at least from about 80° to about 100°, preferably by about 90°, and pressed against the leg.

In order to fix a belt connector to a belt band end of a transport belt, various fixing devices or apparatuses are known from the prior art. In these fixing devices, the fixing of the connector elements is carried out by means of the fixing cramp in two steps. In a first step, the fixing cramp which is supported in the first leg will be pressed with application of force to a cramp rear which connects the two free ends of the fixing cramp so as to penetrate the legs and the belt band end which is supported between them, wherein the free ends, which project at the second leg, of the fixing cramp are bent over on a bending die into an intermediate state. In a subsequent method step, the bent-over free ends are moved into the final end position thereof, that is to say, pressed against the second leg.

For example, WO 2013/103577 A1 discloses a tool for fixing a belt connector to a transport belt, wherein this tool has a plate-like member having a bending die portion and a planar portion, and the fixing of the connector is carried out using a hammer. The previously inserted fixing cramps are driven in by means of the hammer so that the projecting free ends of the fixing cramps are previously bent in the contour of the bending die into an intermediate position. Subsequently, the tool is positioned in such a manner that the free ends, which are previously bent into the intermediate position, of the fixing cramp move into abutment against the planar face of the tool and, with application of force, are bent over at this planar face into the final end position thereof, in which the free ends of the respective fixing cramp move into abutment in bearing pockets of the respective connector element. In this case, the free ends of the respective fixing cramp are bent over in such a manner that the free ends of the respective fixing cramp are bent over toward each other and in a manner offset relative to each other. A problem with such a tool is that the result is highly dependent on the user of the tool so that the results are highly dependent on how carefully the user has worked. Another problem is that, using such a tool, it is impossible to move the fixing cramp or the free ends of the respective fixing cramp into the final position in one and the same position of the tool.

In order to make positioning fixing cramps easier, it is also known from the prior art to use forming dies having two different bending dies, wherein the bending dies are arranged beside each other, wherein one bending die is configured to move the free ends of the fixing cramp into an intermediate position and the other bending die is configured to move an adjacent fixing cramp into a final position. Such a fixing device is disclosed, for example, in DE 195 13 483 C2. Furthermore, U.S. Pat. No. 4,789,092 A discloses such a fixing device. A disadvantage of such fixing devices is that the fixing cramp cannot be moved into the final position in one and the same position of the tool. It is necessary to guide the fixing device further along the belt band end in order to move the respective fixing cramp into the final position. In one and the same position of the tool, the final position of the fixing cramp cannot be reached with such tools.

### Objects And Summary Of The Invention

An object of the present invention is to provide a fixing device which allows the belt connectors to be attached to the belt band end by means of fixing cramps in a particularly rapid and reproducible manner. Furthermore, an object of the present invention is to provide an improved method for fixing belt connectors.

These objects are achieved by a fixing device which has the features of the present invention and by the advantageous embodiments of the present invention. These objects are further achieved by a method which has the features of the present invention.

The fixing device according to the invention is a device for fixing a belt connector to a belt band end of a transport belt by means of fixing cramps, wherein the belt connector has at least one connector element having a first leg and a second leg, wherein the fixing device has a press-in die for pressing in the fixing cramp, a forming die having a bending-over structure for bending over free ends, which project during the pressing-in of the fixing cramp on the second leg, of the fixing cramp on the bending-over structure in the direction of the second leg, and a pressing die which is opposite the press-in die for pressing the free ends, which are bent over on the bending-over structure, of the fixing cramp, wherein the press-in die can be displaced from an initial position into an end position for pressing in a fixing cramp into the legs, wherein the pressing die can be displaced from an initial position into an end position for pressing the bent-over free ends at the second leg, wherein the forming die has a through-opening for the pressing die.

By using a displaceable press-in die and a displaceable pressing die, a high level of precision when positioning the fixing cramp is ensured. The through-opening in the forming die allows the pressing die to pass through the forming die in order to act on the bent-over free ends which are arranged on a front side, facing the press-in die, of the forming die. Therefore, it is not necessary to change the position of the forming die in order to press the free ends. Time is thereby saved.

As a result of the solution according to the invention, the press-in die and the pressing die can be arranged so that they act on the same fixing cramp or the same fixing cramps in one and the same position of the device with respect to the belt band end. The risk of a positioning error is thereby excluded because the initial pressing-in of the fixing cramp and the final pressing of the free ends of the fixing cramp can be or is carried out in one and the same position of the device. Such a configuration also has the advantage that the connector elements do not necessarily have to be fixed in sequence in order to fix the belt connector to the belt band end. In the fixing devices which are known from the prior art, there is normally provision for the connector elements to be fixed by means of fixing cramps along the belt band end sequentially, in this regard in order. This has the disadvantage, particularly with particularly wide belt band ends, that, as a result of working from left to right or from right to left, it may be the case that belt material is pushed up in a wave-like manner, particularly when the belt band end, when the connector elements are positioned, is compressed between the legs of the connector elements. By pushing up material, furthermore, as yet unsecured connector elements can be displaced with respect to their orientation relative to the belt band end and, as a result of pushed-up material, there may also be produced a redirection of the free ends of the fixing cramps during the pressing-in action.

The term “fixing cramp” is particularly intended to be understood to be a fixing element which has two free legs or free ends which are directed in the same direction, often also referred to as cramp tips, and has a cramp rear which connects these two free ends. Preferably, the free ends in the initial state, consequently, before the fixing cramp is positioned or the free ends are bent over and pressed, are bent at an angle of 90° relative to the cramp rear. The free ends of the fixing cramp can certainly be pointed at the respective end thereof in order to facilitate the introduction or passage of the belt band end. Preferably, the press-in die acts on the cramp rear of the fixing cramps.

The legs of the connector elements may have through-holes for the respective fixing cramp. Introduction of the legs during the pressing-in of the fixing cramp is thereby facilitated or even enabled.

The fixing cramp and/or the connector elements preferably comprise metal or a metal alloy, for example, made of zinc-plated steel or high-grade steel.

It is considered to be particularly advantageous if the belt connector is already provided with fixing cramps, for example, the fixing cramps are already introduced into the through-holes of a leg of the respective connector element and retained in these through-holes, for example, in the manner of a press-fit. In this regard, it is not necessary to supply separate fixing cramps to the fixing device.

It is considered to be particularly advantageous if the second leg of the connector element, at which the free ends of the fixing cramp project, has a bearing pocket for receiving the pressed free ends. Preferably, the bearing pocket is configured in such a manner that the pressed free ends do not project relative to the second leg. It is absolutely conceivable that the first leg, against which the cramp rear moves into abutment, has a corresponding bearing pocket for the cramp rear, preferably so that the cramp rear does not project relative to the first leg.

The fixing cramps may be arranged in such a manner that the cramp rears of the fixing cramps extend parallel with the belt band end.

The belt connector may have a plurality of serially arranged connector elements, wherein these connector elements extend along the belt band end. In particular, the belt connector has four or more, particularly more than twenty, connector elements arranged in series.

Furthermore, it is considered to be particularly advantageous if adjacent connectors are connected to each other in the region of the legs, at which the free ends of the fixing cramp project. The other legs of the connector elements are not connected. This has the advantage that these legs can then be closed without influencing the legs of the adjacent connector elements in order to make these legs bear against the belt band end.

Preferably, the forming die is arranged between the pressing die and the press-in die.

The through-opening can absolutely be formed by the forming die being made in two pieces and the two pieces being arranged with spacing from each other. The free region between the pieces then forms the through-opening.

Preferably, the through-opening is in the form of a hole. Such a through-opening can be produced simply and cost-effectively.

Preferably, the through-opening is configured in such a manner that it forms a guide for the pressing die which can be displaced in the through-opening. A particularly high level of precision when pressing the free ends by means of the pressing die is thereby achieved.

In one embodiment of the fixing device, there is provision for the forming die to be displaceable from an initial position into an end position in order to bend over the free ends, which project when pressing in the fixing cramp, of the fixing cramp. Preferably, the forming die is spaced apart from the projecting free ends in the initial position in this case. Consequently, no bending over of the free ends takes place yet during the pressing-in action. In the case of a displaceable forming die, it is considered to be advantageous if the forming die is supported in a leading manner relative to the pressing die and in a displaceable manner on the pressing die in the displacement direction of the pressing die. Initially, the forming die acts on the free ends during displacement of the pressing die into the end position and bends it over in the direction of the second leg. Following the forming die, the pressing die then acts on the bent-over free ends and presses them against the second leg. Preferably, the displacement of the forming die in the direction of the pressing die is carried out counter to the restoring force of a restoring means. In this case, the restoring force may be selected so that the restoring force is sufficiently high to reliably bring about an adequate bending-over action of the free ends before the pressing die has an effect.

In another embodiment, the forming die is configured in a stationary manner, consequently not in a displaceable manner in the direction of the free ends in order to bend over the free ends. Accordingly, the forming die is arranged in such a manner that the free ends during pressing-in of the fixing cramp are pressed by means of the press-in die against the bending-over structure of the stationary forming die and are thereby bent over in the direction of the second leg.

In a particular embodiment, there is provision for the pressing die to act on the tips of the free ends during the pressing operation. The generally sharp tips are thereby reliably pressed.

It is further considered to be particularly advantageous if the bending-over structure and the associated through-opening are configured in such a manner that the bent-over free ends of the fixing cramp project into the through-opening before the pressing action.

It is considered to be particularly advantageous if the bending-over structure is configured in such a manner that the free ends on the bending-over structure are bent over by from 20° to 60°. Preferably, the free ends or free legs are bent over by an angle of from 85° to 95° after the pressing action.

It is considered to be advantageous if the pressing die has a pressing face which acts on the free ends, wherein this pressing face is curved outwardly, in this regard in a convex manner. As a result of the curvature, a material abrasion at the free ends during the action of the pressing die can be minimized. As a result of a curvature, it is further avoided that chips and other undesirable deformations or material flakes occur at the free ends. In principle, however, the pressing face could also be planar or flat. The pressing die is thereby easy to produce and universally usable.

In some applications, however, it may also be advantageous if the pressing face has a structuring in order to achieve a selective bending over of the bent-over free ends during the pressing action, for example, the structuring guides the bending movement of the previously bent free ends during pressing. As a result of such structuring, for example, it is possible to avoid the previously bent free ends moving into abutment one above the other during final pressing, which is undesirable. For example, the pressing face can have a web which is introduced between the previously bent free ends during pressing and thereby keeps them spaced apart. Furthermore, a structuring can avoid material being removed from the free ends, chips and other undesirable deformations or material flakes occurring at the free ends.

Outer edges, which adjoin the pressing face, of the pressing die are preferably provided with a radius or rounded or beveled.

It is absolutely conceivable that an individual through-opening of the forming die and an individual pressing die be associated with the respective free end. Preferably, however, the same through-opening and the same pressing die are associated with the two free ends.

Preferably, the pressing die is arranged outside the through-opening in the initial position and travels into the through-opening only when the pressing die is displaced. The pressing die can thereby be moved along the belt band end independently of the forming die. In such a configuration, there is provision for the device to have a plurality of stationary forming dies and to have a pressing tool which is movable with respect to the belt band end, wherein the pressing tool has the pressing die and the press-in die.

Preferably, the displacement of the press-in die from the initial position into the end position is carried out in the direction of the pressing die and the displacement of the pressing die from the initial position into the end position is carried out in the direction of the press-in die.

It is absolutely conceivable for the movement of the pressing die and/or the press-in die to be a pivot movement. However, it is considered to be particularly preferable for the displacement movement of the press-in die and/or the displacement movement of the pressing die to be a translational movement, in this regard a movement along a straight line. Such a translational movement has the advantage that a particularly precise and reproducible result is achieved. Furthermore, a translational movement has particular advantages if the fixing device is intended to be used for different belt thicknesses and/or differently sized belt connectors. A linear movement of the pressing die and the press-in die ensures that, independently of the belt thickness and independently of the belt connector used, the pressing-in action or pressing action is always carried out in the same direction.

It is absolutely conceivable for the press-in die to have a plurality of portions or a plurality of pressing-in members so that with the press-in die a plurality of fixing cramps can be pressed in at the same time. Similarly, the pressing die can have a plurality of portions or a plurality of pressing members in order to press the free legs of a plurality of fixing cramps simultaneously. Accordingly, the forming die can also have a plurality of bending dies and/or a plurality of through-openings.

It is considered to be particularly advantageous if the bending-over structure is in the form of a bending die. Preferably, this bending die has a first die portion for one leg of the fixing clamp and a second die portion for the other leg of the fixing clamp, wherein the two die portions overlap each other or merge into each other, wherein the through-opening is formed in the overlap region of the two bending die portions. Preferably, the two die portions are configured in an identical manner.

It is considered to be advantageous with regard to a particularly simple production if the two die portions are in the form of partially spherical recesses. Such recesses can be produced particularly simply. The respective recess is arranged in such a manner that bending-over is carried out at the respective recess of one of the two free ends of the cramp. It is thereby possible in a particularly simple manner to achieve bending over inwardly and an offset of the free ends relative to each other.

In order to achieve an offset of the two free ends of the fixing cramp so that the two ends are not located one above the other, it is considered to be particularly advantageous if the bending-over structure is configured in such a manner that it bends over the free ends toward each other, wherein the bending-over action is carried out in such a manner that the previously bent free ends project relative to the cramp rear when viewed from the cramp rear at different sides of the cramp rear. In this regard, the free ends are bent over toward each other but in a manner offset relative to each other. A preferred direction is thereby conferred on the free ends by the previous bending into this intermediate state, wherein this preferred direction is substantially maintained when the pressing die acts so that the two free ends move into abutment against the second leg of the connector element in a substantially parallel and oblique manner relative to the cramp rear in the end position.

It is considered to be advantageous if the press-in die has a base member and a pressing-in member which is supported in the base member and which acts on the fixing cramp, in particular the cramp rear, during the displacement of the press-in die from the initial position into the end position in order to drive in the fixing cramp, wherein the pressing-in member is displaceably supported in the base member in order to change a spacing of the pressing-in member from the forming die in the end position of the press-in die, wherein the press-in die has an operating element which cooperates with the pressing-in member in order to displace the pressing-in member with respect to the base member. As a result of this ability of the spacing of the pressing-in member to be adjusted by the forming die, the fixing device can be adapted in a particularly simple manner to different belt thicknesses and/or different belt connector types and/or different fixing cramps. For example, for thicker belts other belt connectors are used, in which, for example, the spacing of the legs from each other is of different sizes or the legs also have different material thicknesses. Furthermore, it is advantageous with thicker belts to use correspondingly larger fixing cramps. In that the spacing of the pressing-in member from the forming die is adjustable, it is not necessary to change the travel path of the press-in die per se. It is simply necessary to displace the pressing-in member with respect to the base member in order thereby to change the spacing of the pressing-in member from the forming die, whereas the travel path of the press-in die does not have to be adapted. Accordingly, a particularly elegant and simple method for adapting the fixing device to different belt thicknesses and/or connector types and/or fixing cramps is thereby enabled. In a particular embodiment, there is provision for the pressing-in member to project relative to the base member in the direction of the forming die. Accordingly, when the pressing-in member is adjusted, the projection of the pressing-in member is changed with respect to the base member.

Preferably, the pressing-in member is guided linearly in a guiding structure of the base member.

The operating element may be a rotary actuator, in particular a rotary switch which is supported in a fixed manner in the base member, wherein a transmission element which is actively connected to the rotary actuator has a thread which cooperates with a counter-thread which is formed on the pressing-in member. The rotary actuator and the pressing-in member therefore cooperate in the manner of a spindle drive so that, when the rotary actuator is rotated, the base member is accordingly displaced. The transmission element may be in the form of a threaded rod or has a threaded rod. Preferably, the thread is a trapezoidal thread, preferably a trapezoidal thread with a double pitch. Trapezoidal threads have the advantage over metric threads of a greater pitch dimension for the same nominal diameter. A comparatively greater displacement per revolution is thereby achieved.

The rotary actuator may have a locking mechanism in order to lock the rotary actuator, wherein in the locked state a rotation of the rotary actuator is prevented so that in the locked state, despite the great forces when pressing in the fixing cramp, no undesirable displacement of the pressing-in member in the base member occurs because the rotary actuator is prevented from rotating in conjunction with the displacement. The locking mechanism may be formed, for example, in that the rotary actuator has a tooth arrangement, wherein in a locking position the tooth arrangement is engaged with a fixed tooth counter-arrangement, whereby rotation of the rotary actuator is prevented. In a movable position, the tooth arrangement and the tooth counter-arrangement are disengaged and rotation of the rotary actuator is accordingly possible. The movement of the rotary actuator from the locking position into the movable position is preferably carried out by axially displacing the rotary actuator, for example, by pulling out the rotary actuator. Preferably, the rotary actuator can be locked in different rotary positions, that is to say, angular positions. For example, these rotary positions may have a spacing from each other of about 6° so that locking is possible in sixty different rotary positions.

Generally, the belt connectors used are configured in such a manner that the legs of the respective connector element in the initial state are not orientated parallel, for example, they define an angle of approximately 15°. In the connected state, however, the two legs bear on the belt band end so that they are orientated at least substantially parallel. In such connectors, V-shaped belt connectors are often mentioned. In such connectors, the legs of the connector elements must first be closed in that they are pressed against the belt end, in particular therefore any through-holes of the legs are aligned with each other at least approximately. Only then should the fixing cramps be driven in. Otherwise, for example, there is the risk that the legs of the fixing cramp are not introduced into the through-holes of the opposite leg, whereby damage may be caused to the connector element and/or the fixing device. In this regard, it is considered to be particularly advantageous if the fixing device has a pressing jaw, wherein the pressing jaw is supported on the press-in die, preferably on the base member, in a leading manner in the direction of the forming die with respect to the press-in die, wherein the pressing jaw acts on the first leg, which faces the press-in die, of the legs when the press-in die is displaced in order to press the first leg against the belt band end, wherein the pressing jaw is movable counter to the restoring force of a restoring means in the direction of the press-in die. In that the pressing jaw is supported on the press-in die in a leading manner with respect to the press-in die in the displacement direction of the press-in die in the direction of the forming die, it is ensured that initially the pressing jaw acts on the first leg and presses it on the belt band end when the press-in die is displaced, whereby the first leg and the second leg are orientated substantially parallel, in this regard the connector element is closed. Accordingly, any through-openings of the first leg are then also aligned with the through-openings of the second leg. The second leg preferably adjoins the forming die and is supported by it so that, when the pressing jaw acts, the first leg is bent over in the direction of the second leg. The restoring means ensure that excessively great forces are not transmitted to the first legs, whereby damage to the first leg is avoided. Furthermore, the restoring means may also be considered to be advantageous in that the fixing device is suitable for different belt thicknesses or belt connectors with different thicknesses because, as a result of the restoring means, a specific tolerance for different thicknesses is ensured. The restoring means may have a spring or a spring assembly or be formed by a spring or a spring assembly. The restoring means is preferably arranged between the press-in die, preferably the base member of the press-in die, and the pressing jaw. The fixing of the pressing member to the press-in die can be carried out, for example, by means of a screw, in particular a fitting screw, wherein the screw cooperates with the press-in die and the pressing jaw so that a movement of the pressing jaw relative to the press-in die in the displacement direction of the press-in die is enabled and accordingly a deflection of the restoring means is enabled.

It is considered to be particularly advantageous if the pressing jaw has a recess for receiving the fixing cramp, wherein, during the displacement of the press-in die from the initial position into the end position, the press-in die moves into the recess. Preferably, the recess is configured so that, as a result of the recess, a linear guide for the fixing cramp is formed, wherein this guide guides the fixing cramp when the press-in die is displaced so that a deflection of the fixing cramp when positioning the press-in die, in this regard the displacement of the press-in die, from the initial position into the end position is avoided. Incorrect positioning of the fixing cramp is thereby avoided and a high level of reliability of the fixing device is ensured. Furthermore, the reproducibility of the positioning results is increased by a recess in the form of a guide. The recess may be of slot-like form, wherein it is absolutely conceivable that the recess has an expansion in the region of the cramp rear. This may be considered to be advantageous in that a guide is intended to be carried out in the region of the free legs, but instead the region between the two free legs is intended to be configured to be greater so that the cross section of the press-in die can be substantially greater than the cross section of the fixing cramp. A clean pressing-in action of the fixing cramp by the press-in die is ensured by a greater cross-section press-in die.

It is considered to be particularly advantageous if the pressing jaw acts only on the free end of the first leg and does not act on the region of the leg which is formed between the curved portion, which connects the legs, and the fixing cramps or the fixing cramp. Therefore, it is considered to be particularly advantageous if the pressing jaw is formed in a step-like manner in cross section.

As already set out, the belt connectors are generally configured so that they are further opened before connection to the belt end and accordingly the legs have to be initially closed. Generally, the belt connectors are already provided with fixing cramps, wherein these fixing cramps are arranged in the through-openings of the first leg and are retained in the manner of a press-fit. In order to avoid these fixing cramps being bent by the pressing jaw or changed in terms of their orientation with respect to the first leg, it is considered to be particularly advantageous if the pressing jaw has a redirecting edge which is formed at an angle relative to the displacement direction of the press-in die and which cooperates with the fixing cramp, in particular the cramp rear, during displacement of the press-in die. As a result of the redirecting edge, a change of the orientation of the fixing cramp with respect to the first leg during the action of the pressing jaw or the redirecting edge on the fixing cramp is avoided and, at the same time, the redirecting edge ensures that the fixing cramp is introduced into the recess. In this regard, an auxiliary introduction member for the fixing cramp is formed by this redirecting edge. In a linearly displaceable press-in die, the angle defined by the redirecting edge and the displacement direction of the press-in die is preferably between about 40° and about 60°.

In a particular embodiment, there is provision for the press-in die to be guided in a linear guide in order to guide the displacement movement from the initial position into the end position and vice versa, and/or for the pressing die to be guided in a linear guide in order to guide the displacement movement of the press-in die from the initial position into the end position and vice versa, and/or for the pressing jaw to be guided in a linear guide in order to guide the displacement movement of the pressing jaw. For example, the respective guide can be in the form of a sliding guide.

The fixing device may have a first articulation arrangement which cooperates with the press-in die and which has articulation members which can be pivoted relative to each other, wherein the first articulation arrangement is in the form of a toggle lever, and wherein the fixing device has a second articulation arrangement, which cooperates with the pressing die and which has articulation members which can be pivoted relative to each other. The articulation arrangements are coupled to each other, whereby the two dies can be displaced together. The first and second articulation arrangements are coupled to each other in this case so that, when the articulation arrangements are actuated in order to displace the dies from the respective initial position into the respective end position, initially the press-in die reaches the end position, wherein the first articulation arrangement in the end position is in a dead center position and, at a subsequent time, the pressing die reaches the end position. This type of coupling ensures that the fixing cramp is completely driven in before the press-in die acts on the free ends. In principle, it is absolutely conceivable for the press-in die already to be moved in the direction of the press-in die before reaching the dead center position, but the pressing die does not yet contact the free ends of the fixing cramp during this movement. In that the first articulation arrangement is in the dead center position, the fixing cramp is supported by the opposite press-in die during pressing of the bent-over free ends against the second leg by means of the pressing die because, as a result of the first articulation arrangement which is located in the dead center position, undesirable displacement of the press-in die in the direction of the initial position is reliably prevented when the pressing die acts.

The articulation members are preferably in the form of levers. In order to ensure the chronological sequence of the displacement movements of the press-in die and the pressing die, there is provision in a particular embodiment for a first lever of the second articulation arrangement to have a free-running contour and for a second lever of the second articulation arrangement to be supported in an articulated manner in this free-running contour. The free-running contour may, for example, be in the form of an elongate hole. The free-running contour allows a non-loaded path in the second articulation arrangement so that, when the first articulation arrangement is actuated, the second lever of the second articulation arrangement is not moved despite the coupling between the first and second articulation arrangements. The movement of the second lever preferably only begins when the first articulation arrangement reaches or has reached the first dead center position.

The first articulation arrangement may comprise two levers, wherein the first lever is freely pivotable and accordingly does not have any fixed pivot axis and the second lever is pivotable about a fixed pivot axis and is coupled to the press-in die. The second articulation arrangement may also comprise two levers, wherein the first lever is freely pivotable and accordingly does not have any fixed pivot axis and the second lever is pivotable about a fixed pivot axis.

The fixing device may have a drive for displacing the press-in die and/or the pressing die. Preferably, the drive cooperates with an articulation arrangement which in turn cooperates with the dies. The drive is preferably a linear drive. The drive of the fixing device is preferably a piston/cylinder unit. The piston/cylinder unit is preferably a pneumatic or hydraulic or electric cylinder.

However, it is also completely conceivable for the fixing device to have a rotatable shaft having a coupling structure for torque-transmitting connection to a corresponding coupling counter-structure of an external rotary drive instead of the drive or in addition to the drive. The external rotary drive may be, for example, a screwdriver, in particular an electromotive screwdriver. The coupling structure may be configured as known from screw heads. For example, the coupling structure may be in the form of an internal hexagon socket, external hexagon socket, internal square socket or external square socket. Preferably, the rotational movement of the shaft is converted into a translational movement of a transmission element, as known, for example, from spindle drives. The shaft may have, for example, a thread portion, wherein the transmission element has a counter-thread which cooperates with the thread so that, when the coupling structure is rotated, the transmission element is linearly displaced in accordance with the thread pitch. Preferably, the transmission element cooperates with an articulation arrangement which in turn cooperates with the dies.

In one embodiment with an above-described articulation arrangement, the coupling between the articulation arrangement and the drive is preferably brought about via a drive rod which is connected in an articulated manner to one of the levers of the articulation arrangements. Preferably, the first articulation arrangement is connected to the drive by means of the drive rod, wherein the drive rod is connected in an articulated manner to the first lever of the first articulation arrangement via a connection means, for example, a bolt. The connection means is guided in a guide structure which is secured to the housing along a curved path, wherein a dead center portion of this curved path is configured in such a manner that, when the dead center portion is travelled, the first articulation arrangement remains in a dead center position despite pivoting of the first lever of the first articulation arrangement. This can be brought about, for example, in that the dead center portion of the curved path describes a circular arc about a pivot axis between the first lever and the second lever, which is connected to the first lever in an articulated manner, of the first articulation arrangement.

In a preferred embodiment of the fixing device, the fixing device has a frame, wherein the frame has a bearing rail for supporting the belt band end with a belt connector arranged thereon, wherein a plurality of forming dies are formed or arranged in the bearing rail along a longitudinal extent of the bearing rail, and wherein the fixing device has a pressing tool, wherein the pressing tool has the press-in die and the pressing die, wherein the bearing rail is arranged between the press-in die of the pressing tool and the pressing die of the pressing tool.

The frame may have a guide rail which is not identical to the bearing rail, wherein the pressing tool is supported in the guide rail in a displaceable manner along the bearing rail, consequently along the belt band end. In that the pressing tool is supported in a guide rail which is not identical to the bearing rail, the bearing rail is not loaded by the inherent weight of the pressing tool because no support of the pressing tool takes place on the bearing rail. Accordingly, the bearing rail is loaded only by the inherent weight of the belt band end and by the belt connectors which are arranged on it. The loading is relatively small so that no particularly high demands have to be placed on the mechanical stability of the bearing rail. Accordingly, the bearing rail can be produced simply and cost-effectively. For example, the bearing rail can be produced from a thin flat steel. The flat steel can have a relatively small material thickness as a result of the small mechanical loading, for example, have a material thickness of from 4 mm to 10 mm.

It is considered to be particularly advantageous if the frame has two guide rails which extend parallel, wherein the two guide rails are configured under the bearing rail in a vertical direction of the fixing device when using the fixing device, and the bearing rail is configured between the two guide rails when the fixing device is viewed from above. The guide of the pressing tool in the respective guide rail can be in the form, for example, of a sliding guide, in particular a roller-mounted sliding guide. A profile guide is also conceivable.

It is considered to be particularly advantageous if the forming dies are in the form of separate components, wherein the bearing rail has bearing receiving members, wherein the forming dies are supported in the bearing receiving members, in particular inserted therein, wherein the bearing receiving members again have through-openings for the pressing die at least in the region of the through-openings of the forming dies. Since the forming dies are the components of the frame which are subjected to a particularly high mechanical loading and corresponding wear, the configuration of these components as separate components is particularly advantageous since the forming dies can be produced from a different material from that of the bearing rail, in particular produced from a lower-wear, in particular harder, material, for example, tool steel. In an embodiment in which the forming dies are an integral component of the bearing rail, this would not be possible. In such a case, the entire bearing rail would have to be produced from a correspondingly suitable material, whereby again the production costs of the frame would be higher. Furthermore, the use of forming dies which are in the form of separate components has the advantage that a worn forming die can be changed in a simple manner. Furthermore, by changing the forming die for a forming die with a differently configured bending-over structure, the frame can be used for different connectors and/or different fixing cramps. In order to adapt, the forming dies simply have to be changed.

Preferably, the bearing receiving members for the forming dies are in the form of through-openings, wherein the forming dies are inserted in these bearing receiving members and bear against a support structure at the rear with gravitational support. The support structure may, for example, be one or more support rails which are attached to the bearing rail at the rear. The support rails can, for example, be screwed to the bearing rail

It is completely conceivable for the forming dies to be secured with a securing means which cooperates with the bearing rail and/or the support rails. The securing means may, for example, be a screw which is screwed into the forming die and which cooperates with the bearing rail and/or the support rails. The securing means ensure inadvertent removal of the forming die from the bearing rail.

The forming dies which are in the form of separate components are preferably configured in a block-like manner and have a thickness which preferably corresponds at least to the thickness of the bearing rail.

In order to further reduce the mechanical loading of the bearing rail during the positioning operation of the fixing cramp, in a particular embodiment of the invention there is provision for the pressing tool to have a support structure for supporting the respective forming die on the side, which faces away from the press-in die, of the forming die during the operation of pressing in the fixing cramp by means of the press-in die, wherein the respective forming die is supported on a resiliently deformable restoring means in the bearing rail so that, when the press-in die applies force to the forming die, the forming die moves into abutment against the support structure with the restoring means being deformed, and, without any application of force by the press-in die to the forming die, the forming die is spaced apart from the support structure. By supporting the forming die on the support structure on the tool, accordingly the forces applied when the fixing cramp is pressed in are not introduced into the bearing rail per se, but instead via the support structure into the pressing tool. Accordingly, the bearing rail is not mechanically loaded or is mechanically loaded at least only slightly. The bearing rail is accordingly not loaded at all when the fixing cramp is pressed in or is loaded only very slightly, that is to say, in the order of magnitude of the restoring force of the restoring means. In the unloaded state, however, the forming die is spaced apart from the support structure so that the support structure does not contact the forming dies during displacement of the pressing tool with respect to the bearing rail and accordingly the forming dies do not impede the displacement of the pressing tool with respect to the bearing rail. Preferably, the spacing of the forming die from the support structure is from about 0.3 mm to about 0.7 mm in the unloaded state. Particularly, the spacing is approximately 0.5 mm.

In particular, the pressing tool comprises a housing, wherein in this housing the first articulation arrangement, the second articulation arrangement, the press-in die and the pressing die are supported.

The pressing tool may be a pneumatically drivable pressing tool, wherein the pressing tool particularly has a drive which is in the form of a pneumatic cylinder. When the pneumatic drive is actuated, for example, by corresponding application of pressure of a pneumatic cylinder, the press-in die and/or the pressing die travel(s) from the initial position into the end position. In order to avoid the pneumatic drive being actuated in a position of the pressing tool in which the pressing tool is not correctly positioned with respect to the connector element to be fixed, the pressing tool comprises in an advantageous embodiment a mechanically actuatable valve having a valve body and a valve piston which is displaceable in the valve body between a first end position and a second end position, wherein in both end positions of the valve piston actuation of the drive, for example, a pressure application of the pneumatic cylinder, is prevented and, in the intermediate position between the two end positions, actuation of the drive is possible, wherein, during displacement of the pressing tool in the frame, the valve piston cooperates with a portion, which is formed along the displacement path, of the frame, preferably a portion of the bearing rail, wherein the portion has a structuring, wherein the structuring is configured in such a manner that the valve piston is in the intermediate position only in pressing-in positions of the pressing tool in which the pressing die can move into the through-opening of the forming die.

Accordingly, the valve ensures that a positioning or closing of the pressing tool can occur only in the pressing-in positions. In that an actuation of the drive of the pressing tool is possible only in the intermediate position, the pressing tool is prevented from being actuated inadvertently if the pressing tool is not in the frame. An acceptance range of the intermediate position, consequently the acceptance range in which actuation of the drive is possible, is in the range of a few millimeters, particularly in the range from about 1 mm to about 3 mm, preferably in the range from about 1 mm to about 2 mm. In that actuation is possible only in an intermediate position of the valve body, no state in which actuation of the pressing tool is possible can be brought about by imprecisely pressing down the valve piston because pressing down leads to one of the two end positions of the valve body, in which actuation of the pressing tool is impossible.

The valve piston may be resiliently loaded. Accordingly, a displacement of the valve piston counter to the resilient force of the spring is brought about. In a basic state of the valve, the valve is in one of the two end positions.

It is considered to be particularly advantageous if the portion having the structuring is a component of the bearing rail.

The structuring is preferably in the form of a hole pattern.

The valve may be arranged at the same side of the bearing rail as the pressing die. Accordingly, it is considered to be particularly advantageous if the valve piston cooperates with a lower side of the bearing rail.

It is considered to be particularly advantageous with regard to simplifying the displaceability of the pressing tool if a running wheel is fitted to the valve body, in particular the valve has a roller tappet, wherein this running wheel cooperates with the structured portion. The running wheel also promotes the travel over the structuring.

The displacement of the valve piston may be carried out perpendicularly to the displacement movement of the pressing tool along the bearing rail.

It is completely conceivable for the valve to be used simply for switching control air, wherein this control air is again used to switch a control valve which supplies compressed air to the drive of the pneumatic cylinder depending on the applied control air in order to actuate the drive.

In a particular embodiment of the pressing tool, the pressing tool is a pressing tool which is intended to be operated by an operator, wherein the triggering of a pressing operation, in this regard an actuation of the drive, has to be carried out manually on the pressing tool. To this end, the pressing tool has a first operating apparatus for one hand of the operator and a second operating apparatus for the other hand of the operator, wherein these two operating apparatuses have to be operated simultaneously in order to actuate the drive. The two operating apparatuses are fitted to the pressing tool in such a manner that operating the operating apparatuses is possible only using both hands of the operator, consequently in a two-handed manner. However, the actuation of the drive can be carried out only when the valve which cooperates with the structuring is in the intermediate position. Preferably, the operating apparatuses are also provided with mechanically actuatable valves, in particular in the form of push-buttons, which form a pneumatic control chain together with the valve which cooperates with the structuring in order to prevent inadvertent operation of the drive. Only when all three valves are in the correct switching position is the drive actuated. Should one valve not be in the correct switching position, the drive is not actuated. The valve which cooperates with the structuring, the valve which cooperates with one operating apparatus and the valve which cooperates with the other operating apparatus can be connected in series to this end so that only when all three valves are in a conducting position is the drive actuated. Preferably, control air flows in the conducting position of the valves to a control connection of a pneumatically actuatable pneumatic valve in order to switch the pneumatic valve, wherein, when control air is applied to the control connection of the pneumatic valve, the pneumatic valve is moved into a switching position in which a pneumatic drive is acted on with compressed air so that the dies are moved into the end positions.

In the method according to the invention for fixing a belt connector to a belt band end, there is provision for this method to be carried out using the fixing device according to the invention or one of the advantageous embodiments of the fixing device. The method has the following steps:
a) arranging a connector element of the belt connector with a belt band end which is arranged between the legs of the connector element between the press-in die and the forming die,
b) pressing in at least one fixing cramp so as to penetrate the belt band end which is arranged between the legs of the connector element by displacing the press-in die from the initial position into the end position,
c) bending over the projecting free ends of the fixing cramp on the bending-over structure of the forming die in the direction of the second leg,
d) pressing the bent-over free ends of the fixing cramp against the second leg by displacing the pressing die from the initial position into the end position, wherein the step d) is carried out chronologically after the step c) and wherein the steps b), c) and d) are carried out in one and the same position of the fixing device with respect to the connector element.

The steps b) and c) are preferably carried out simultaneously, that is to say, when the fixing cramp is pressed in, the projecting free ends are pressed against the bending-over structure and thereby bent over in the direction of the second leg.

The step a) is preferably carried out using a frame and a pressing tool in that initially the belt connector with the belt band end is arranged in the frame and subsequently the mobile pressing tool is positioned with respect to the frame in accordance with the connector element to be fixed.

A number of aspects of the fixing device can also be used in fixing devices which do not necessarily have a forming die and/or a pressing die. If features are not related to the forming die and/or a pressing die, they can also generally be used in a fixing device.

In this context, the present disclosure particularly also relates to the following aspects of subject-matter:

Aspect 1: A fixing device for fixing a belt connector to a belt band end of a transport belt by means of fixing elements, for example, fixing cramps or rivets, wherein the belt connector has at least one connector element having a first leg and a second leg, wherein the fixing device has a frame and a pressing tool having a pneumatic drive, wherein the pressing tool has a press-in die, wherein by displacing the press-in die from an initial position into an end position the fixing element can be pressed into the legs of the connector element so as to penetrate the belt band end, wherein the frame has a bearing rail for supporting the belt band end with a belt connector arranged thereon, wherein the frame has a guide rail, wherein the pressing tool is supported in the guide rail in a displaceable manner along the bearing rail, consequently along the belt band end, wherein the pressing tool has a mechanically actuatable valve having a valve body and a valve piston which is displaceable in the valve body between a first end position and a second end position, wherein actuation of the drive is prevented in both end positions of the valve piston and, in the intermediate position between the two end positions, actuation of the drive is possible, wherein, during a displacement of the pressing tool in the frame, the valve piston cooperates with a portion, formed along the displacement path, of the frame, wherein the portion has a structuring, wherein the structuring is formed so that the valve piston is in the intermediate position only in pressing-in positions of the pressing tool, in which a pressing-in action of the fixing element is possible by displacing the press-in die.

Aspect 2: A fixing device according to aspect 1, wherein the guide rail is not identical to the bearing rail.

Aspect 3: A fixing device according to aspect 1 or aspect 2, wherein a running wheel is fitted to the valve body, in particular the valve has a roller tappet, wherein this running wheel cooperates with the structured portion.

Aspect 4: A fixing device according to any one of aspects 1 to 3, wherein the pressing tool has a first operating apparatus for one hand of an operator and a second operating apparatus for another hand of the operator, wherein these two operating apparatuses have to be operated at the same time in order to actuate the drive, wherein both operating apparatuses are fitted to the pressing tool in such a manner that operating the operating apparatuses is possible only using both hands of the operator, consequently in a two-handed manner.

Aspect 5: A fixing device according to aspect 4, wherein the operating apparatuses are also provided with mechanically actuatable valves, particularly in the form of push-buttons, which form a pneumatic control chain together with the valve which cooperates with the structuring in order to prevent inadvertent operation of the drive. Only when all three valves are in the correct switching position is the drive actuated. Should one valve not be in the correct switching position, the drive is not actuated. The valve which cooperates with the structuring, the valve which cooperates with one operating apparatus and the valve which cooperates with the other operating apparatus can be connected in series to this end so that only when all three valves are in a conducting position is the drive actuated. Preferably, control air flows in the conducting position of the valves to a control connection of a pneumatically actuatable pneumatic valve in order to switch the pneumatic valve, wherein, when control air is applied to the control connection of the pneumatic valve, the pneumatic valve is moved into a switching position in which a pneumatic drive is acted on with compressed air so that the press-in die is displaced from the initial position into the end position.

Aspect 6: A fixing device for fixing a belt connector to a belt band end of a transport belt by means of fixing elements, for example, fixing cramps or rivets, wherein the belt connector has at least one connector element having a first leg and a second leg, wherein the pressing tool has a press-in die, wherein by displacing the press-in die from an initial position into an end position the fixing element can be pressed into the legs of the connector element so as to penetrate the belt band end, wherein the fixing device has a pressing jaw, wherein the pressing jaw is supported on the press-in die in a leading manner in the direction of the forming die with respect to the press-in die, wherein the pressing jaw acts on the first leg, which faces the press-in die, of the legs when the press-in die is displaced in order to press the first leg against the belt band end, wherein the pressing jaw is movable counter to the restoring force of a restoring means in the direction of the press-in die.

Aspect 7: A fixing device according to aspect 6, wherein the restoring means has a spring which is arranged between the press-in die and the pressing jaw.

Aspect 8: A fixing device for fixing a belt connector to a belt band end of a transport belt by means of fixing elements, for example, fixing cramps or rivets, wherein the belt connector has at least one connector element having a first leg and a second leg, wherein the pressing tool has a press-in die, wherein by displacing the press-in die from an initial position into an end position the fixing element can be pressed into the legs of the connector element so as to penetrate the belt band end, wherein the press-in die has a base member and a pressing-in member which is supported in the base member and which acts on the fixing element during displacement of the press-in die from the initial position into the end position in order to drive the fixing element, wherein the pressing-in member is displaceably supported in the base member in order to change a position of the pressing-in member in the end position of the press-in die, wherein the press-in die has an operating element which cooperates with the pressing-in member in order to displace the pressing-in member with respect to the base member.

### BRIEF DESCRIPTION OF THE DRAWING FIGURES

In the following drawing figures, the present invention is shown and described in greater detail with reference to exemplary embodiments without being limited to these embodiments.

FIG. 1 shows a fixing device comprising a frame and a pressing tool as a perspective illustration obliquely from the front.

FIG. 2 shows the fixing device according to FIG. 1 as a perspective view obliquely from the rear.

FIG. 3 shows components of the fixing device according to FIG. 1 as a side view.

FIG. 4 shows components of the fixing device as a sectioned view according to the line IV-IV in FIG. 3.

FIG. 5 shows components of the fixing device according to FIG. 1 with an inserted belt band end and a belt connector arranged thereon as a sectioned view.

FIG. 5a shows a part-region of FIG. 5 as an enlarged view.

FIG. 6 shows the fixing device as a view according to FIG. 5 during the operation of fixing the belt connector to the belt band end with a press-in die in an initial position and a pressing die in an initial position.

FIG. 7 shows a view of the fixing device as in FIG. 6 with the press-in die and the pressing die in an intermediate position.

FIG. 8 shows a view of the fixing device as in FIG. 6 with the press-in die in an end position and the pressing die in an intermediate position.

FIG. 9 shows a view of the fixing device as in FIG. 6 with the press-in die in the end position and the pressing die in an end position.

FIG. 10 shows a view of the fixing device as in FIG. 6 with the press-in die in the initial position and the pressing die in the initial position.

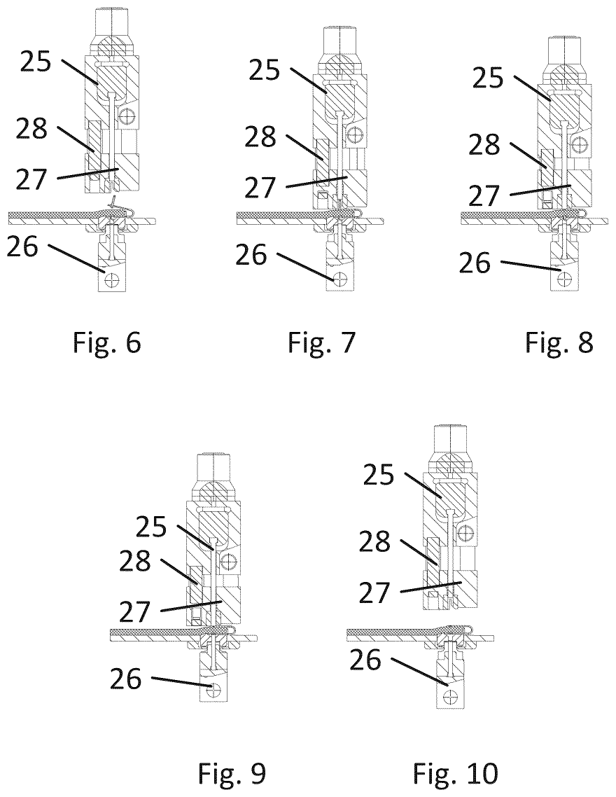

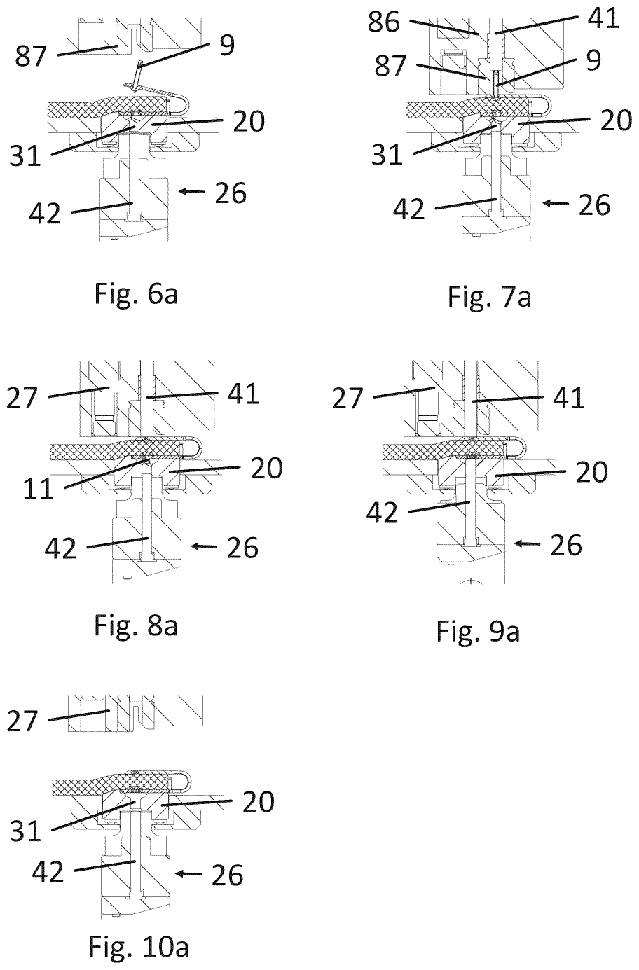

FIG. 6a shows a part-region of FIG. 6 as an enlarged view.

FIG. 7a shows a part-region of FIG. 7 as an enlarged view.

FIG. 8a shows a part-region of FIG. 8 as an enlarged view.

FIG. 9a shows a part-region of FIG. 9 as an enlarged view.

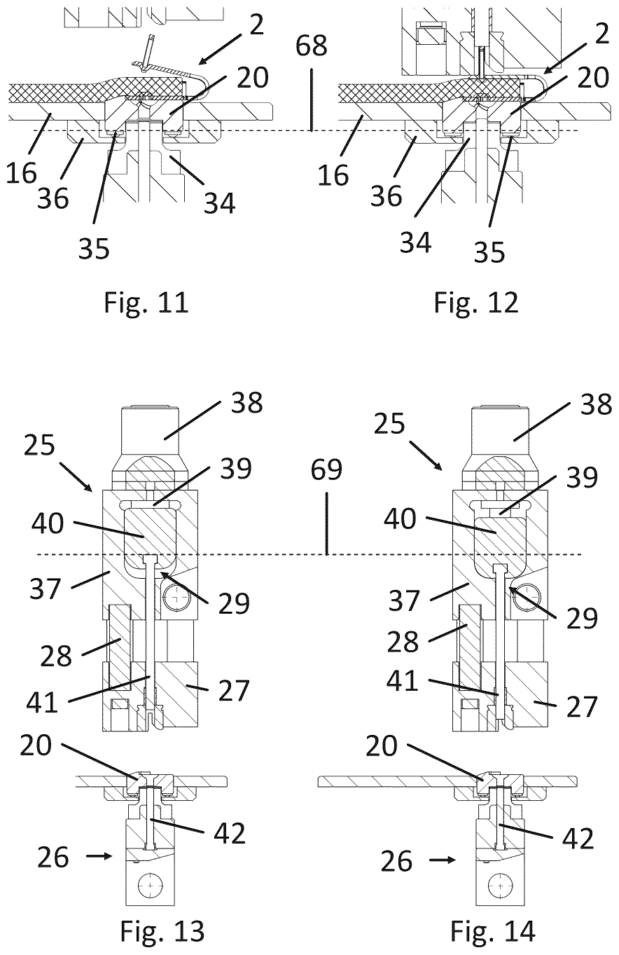

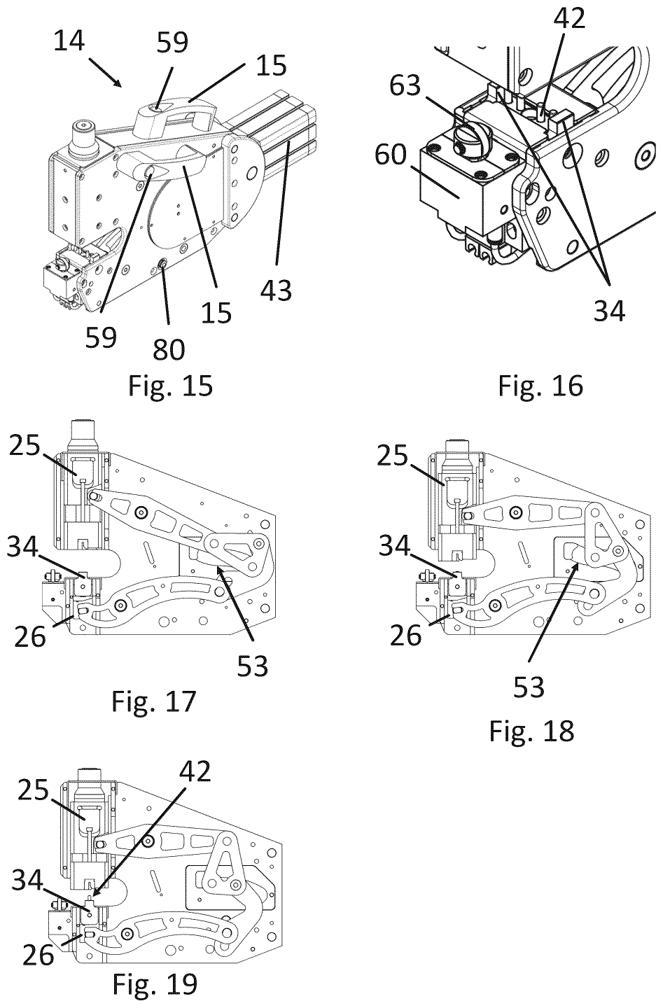

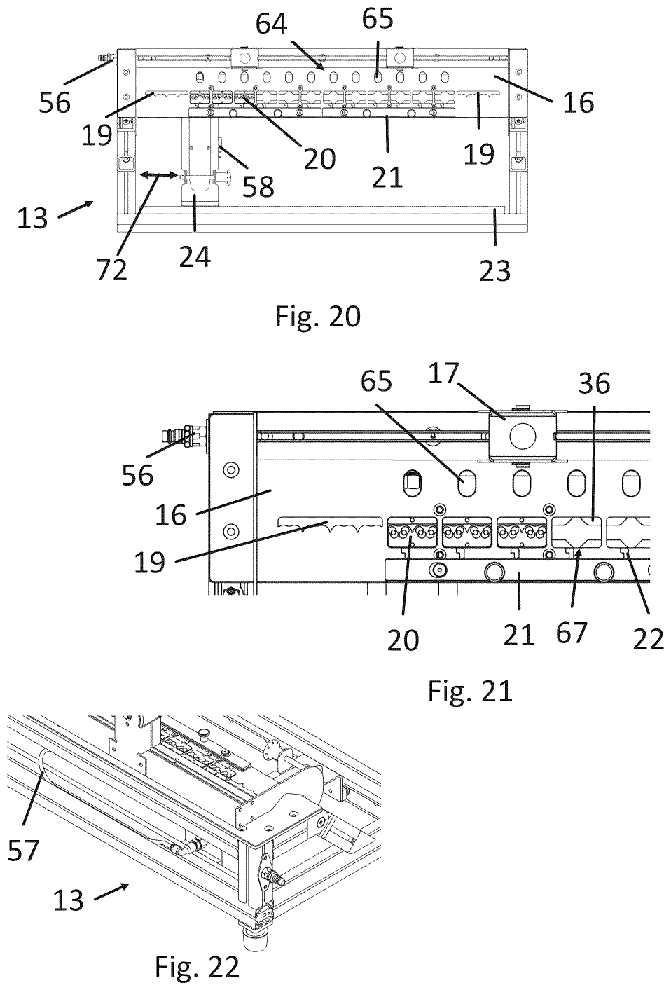

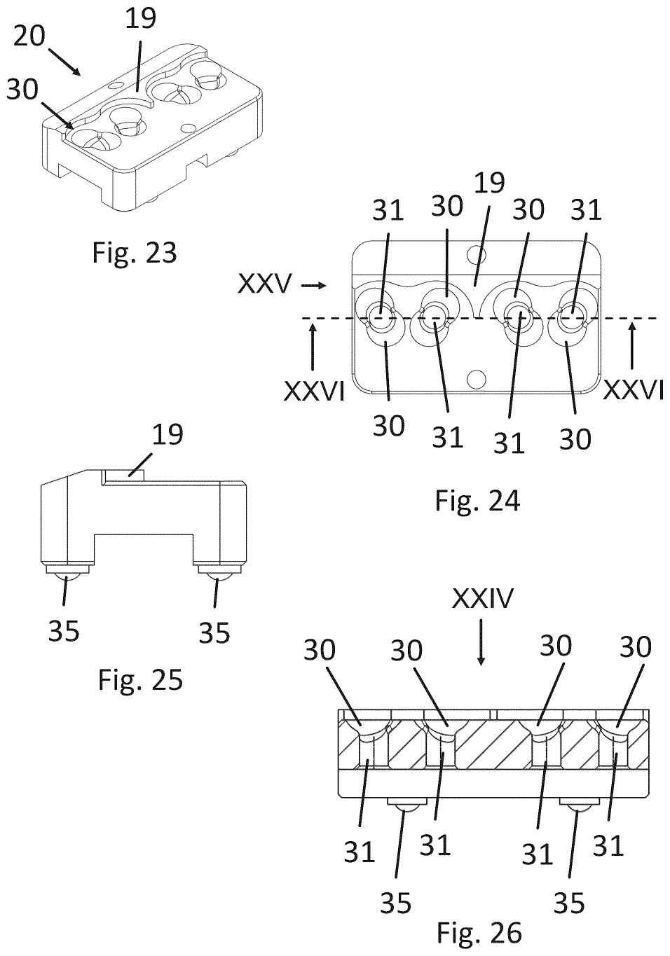

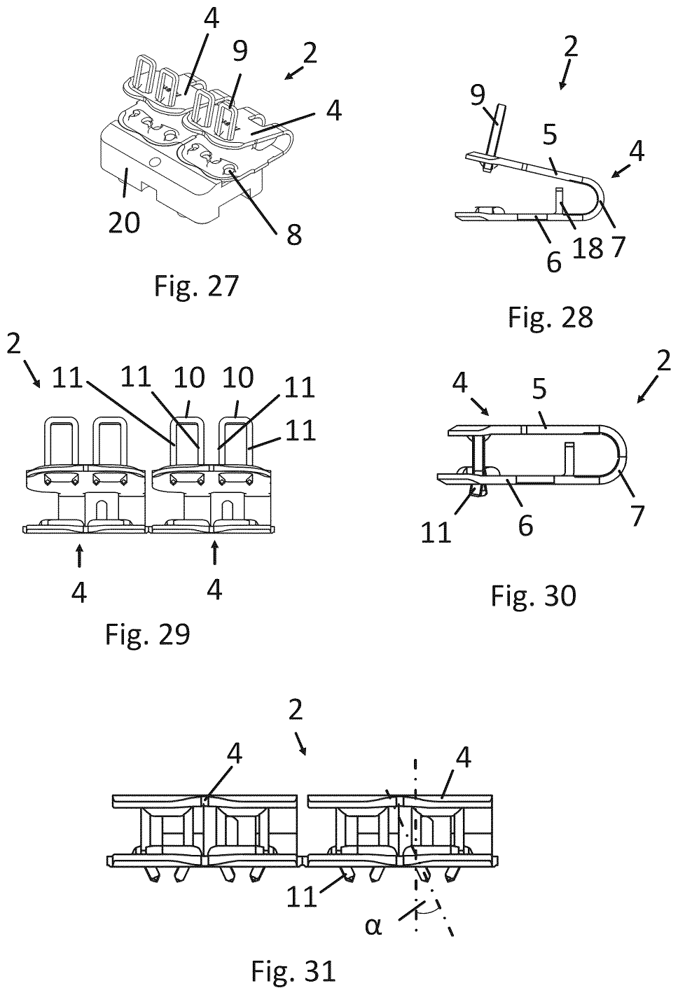

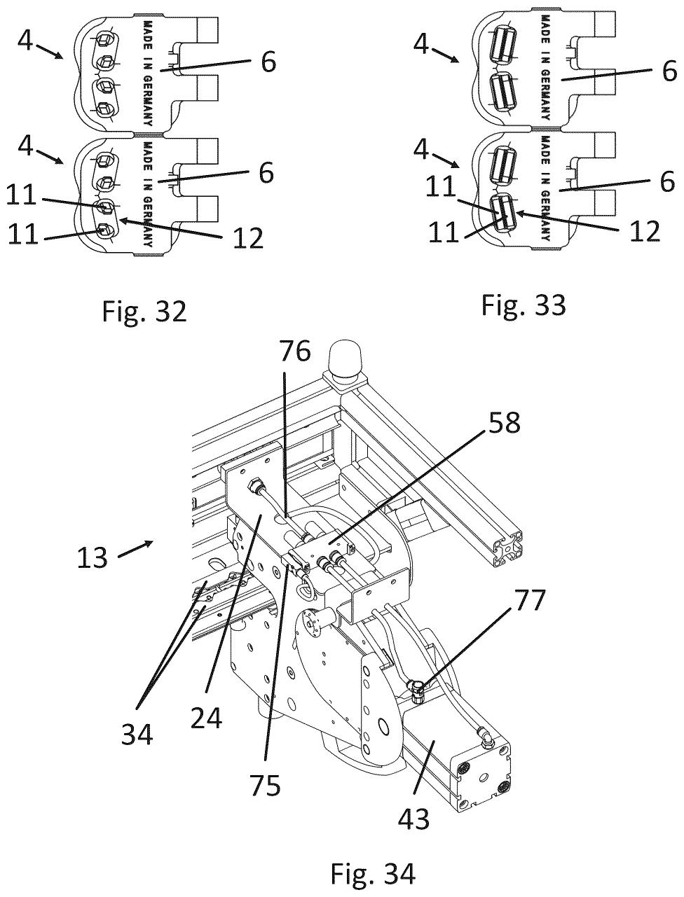

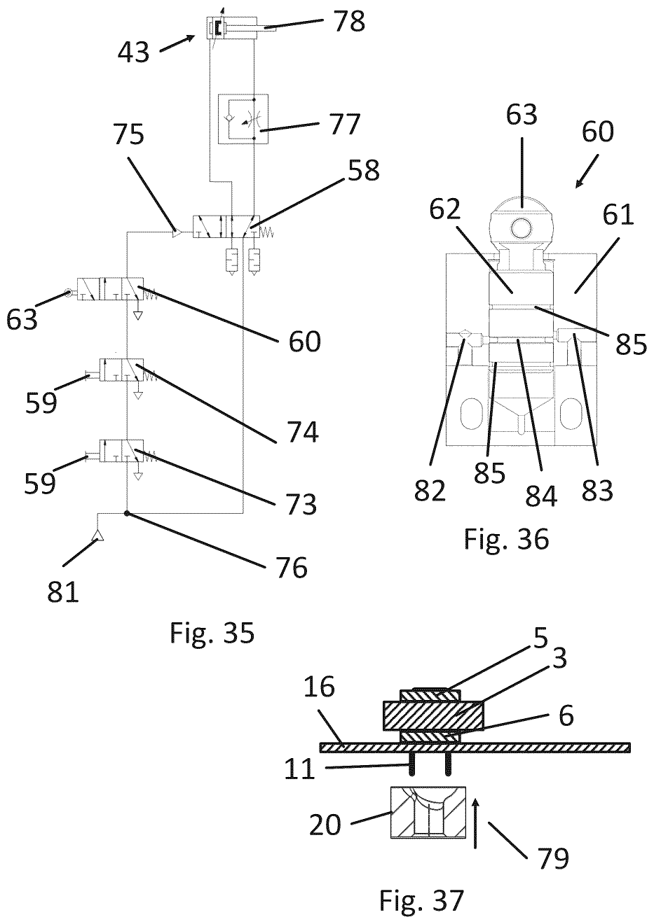

FIG. 10a shows a part-region of FIG. 10 as an enlarged view.

FIG. 11 shows a part-region of FIG. 6 as an enlarged view.

FIG. 12 shows a part-region of FIG. 7 as an enlarged view.

FIG. 13 shows a part-region of the fixing device in a setting for thick belts as a sectioned view.

FIG. 14 shows the fixing device in a setting for thin belts as a view as in FIG. 13.

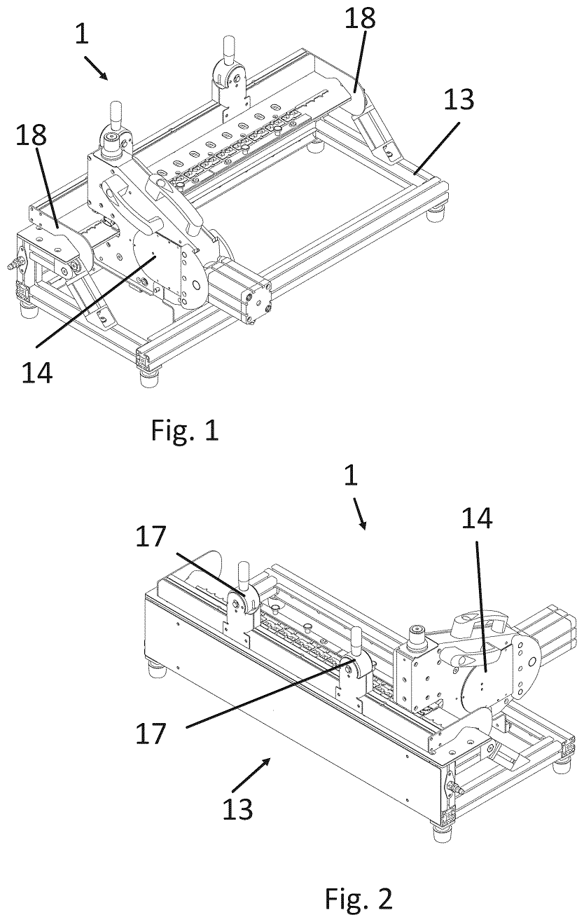

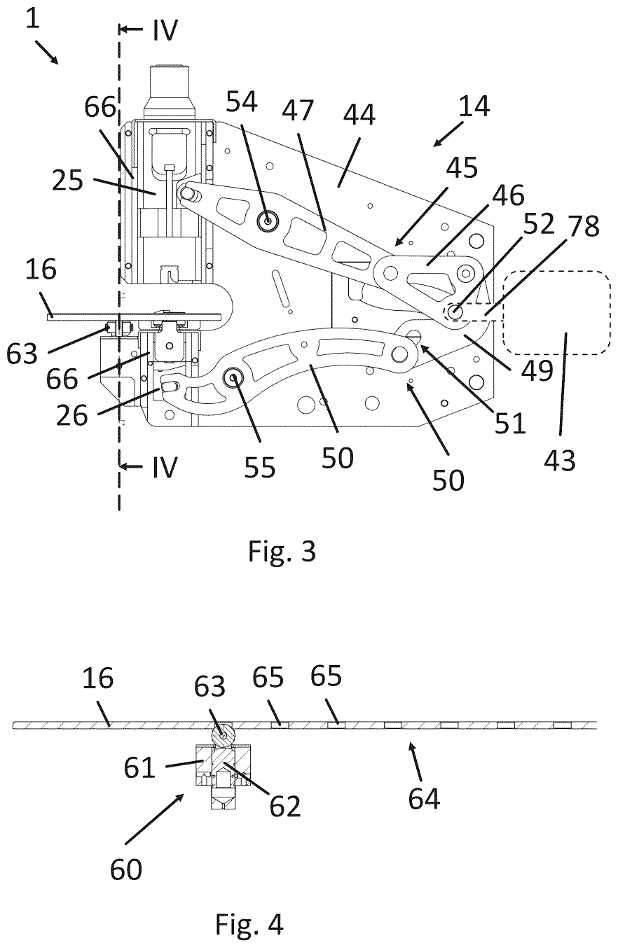

FIG. 15 shows the pressing tool of the fixing device according to FIG. 1 as a perspective illustration, as in FIG. 2.

FIG. 16 shows a part-region of FIG. 15 as an enlarged view.

FIG. 17 shows an internal view of the pressing tool according to FIG. 15 with the press-in die in the initial position and the pressing die in the initial position.

FIG. 18 shows the pressing tool according to FIG. 17 with the press-in die in the end position.

FIG. 19 shows the pressing tool according to FIG. 17 with the press-in die in the end position and the pressing die in the end position.

FIG. 20 shows the frame of the fixing device as a plan view.

FIG. 21 shows a part-region of FIG. 20 as an enlarged view.

FIG. 22 shows a part-region of the frame according to FIG. 20 as a perspective view obliquely from the rear.

FIG. 23 shows a forming die of the fixing device according to FIG. 1 as a perspective view.

FIG. 24 shows the forming die according to FIG. 23 as a plan view according to the arrow XXIV in FIG. 26.

FIG. 25 shows the forming die as a view according to the arrow XXV in FIG. 24.

FIG. 26 shows the forming die as a sectioned view according to the line XXVI-XXVI in FIG. 24.

FIG. 27 shows the forming die according to FIG. 23 with a belt connector arranged thereon as a perspective view.

FIG. 28 shows the belt connector according to FIG. 27 in a basic state as a side view.

FIG. 29 shows the belt connector according to FIG. 28 as a front view.

FIG. 30 shows the belt connector according to FIG. 28 with a bent-over fixing cramp.

FIG. 31 shows the belt connector according to FIG. 30 as a front view.

FIG. 32 shows the belt connector according to FIG. 30 as a bottom view.

FIG. 33 shows the belt connector with a pressed-on fixing cramp as a bottom view.

FIG. 34 shows a part-region of the fixing device obliquely from below.

FIG. 35 shows a pneumatic circuit diagram.

FIG. 36 shows an internal view of a valve used.

FIG. 37 shows an additional embodiment as a schematic illustration.

### DETAILED DESCRIPTION OF EXEMPLARY EMBODIMENTS

FIGS. 1 and 2 show a fixing device 1 for fixing a belt connector 2 to a belt band end 3 of a transport belt. The belt connector 2 has at least one connector element 4, generally a plurality of connector elements 4 which are arranged in series. The present fixing device 1 is used to fix belt connectors 2 to belt band ends 3 of conveyor belts, wherein the conveyor belts may have a thickness of from about 1.5 mm to about 6.4 mm. In this case, it is absolutely conceivable that different belt connector types which are suitable for different belt thickness ranges can be fixed with the present fixing device 1.

A belt connector 2 with two connector elements 4 which are arranged in series is illustrated in greater detail in FIGS. 27 to 33. The respective connector element 4 has a first plate-like leg 5 and a second plate-like leg 6, wherein two curved portions 7 of the connector element 4 connect the legs 5, 6 of the connector element 4 to each other. The connector elements 4 of the belt connector 2 are connected to each other in the region of the second leg 6. The respective leg 5, 6 has through-holes 8 for fixing cramps 9 for fixing the connector element 4 to the belt band end 3. As can be seen in particular in FIGS. 28 and 29, in the respective connector element 4, that is to say, in the upper first leg 5, two fixing cramps 9 are already introduced, wherein these fixing cramps 9 are retained in the through-holes 8 of the first leg 5 in the manner of a press-fit. Cramp rears 10 of the fixing cramps 9 extend in this instance parallel with a front edge of the belt band end 3. In order to fix the belt connectors 2 to the belt band end 3, the legs 5, 6 have to be closed so that they move into abutment against the belt band end 3. Furthermore, the fixing cramps 9 have to be driven through the through-holes 8 of the two legs 5, 6 so as to penetrate the belt band end 3 which is arranged between the legs 5, 6 of the connector element 4. The free ends 11, which project at the side, facing away from the belt band end 3, of the lower, second leg 6, of the fixing cramp 9 then have to be bent over and pressed against the second leg 6 so that they are bent over by approximately 90° and move into abutment against the second leg 6. This final end state is shown in FIG. 33 by way of example. In specific terms, the free ends 11 of the respective fixing cramp 9 in the final end state move into abutment in a bearing pocket 12 which is associated with this fixing cramp 9 so that these free ends 11 in the end state do not project with respect to the second leg 6 or project only slightly with respect to the second leg 6.

In order to connect two belt band ends 3, belt connectors 2 are fixed at the two band ends 3. These belt connectors 2 are then arranged in an overlapping manner so that the curved portions 7 mesh with each other. A connector rod is then inserted into the meshing curved portions 7 in order to connect the band ends 3.

The belt connector 2 is fixed to the belt band end 3 with the fixing device 1, as shown in FIG. 1. This fixing device 1 comprises a frame 13 which is illustrated in greater detail in FIGS. 20 to 22 and a pressing tool 14 which is in the form of a set of press-in tongs. This pressing tool 14 is guided manually by an operator of the device, to which end the pressing tool 14 has handles 15 (FIG. 15). The positioning operation, in this regard the fixing of the connector elements 4 by means of the fixing cramps 9, is triggered manually on the pressing tool 14. The pressing tool 14 is manually actuated, not automatically.

A bearing rail 16 of the frame 13 acts as a support face for the belt band end 3 with the belt connector 2 arranged thereon. In a frame which is formed above the bearing rail 16, a clamping strip which can be positioned in the direction of the bearing rail 16 is arranged, wherein the positioning of the clamping strip is carried out by means of the clamping lever 17 which acts on the clamping strip. With this clamping rail, the belt band end 3 can be retained in the frame 13 in a clamping manner. The frame is connected to the remaining frame 13 so that belt band ends 3 which are longer than the longitudinal extent of the bearing rail 16 can also be arranged on the bearing rail 16. To this end, the frame is connected via curved retention struts in the form of delimiter elements 18 to the remaining frame 13, wherein these retention struts 18 form a laterally open receiving region which is open at the rear together with the bearing rail 16 for the belt band end 3. The term “rear side of the frame 13” is intended to be understood in this instance to mean the side which is intended to be turned away from the operator of the pressing tool 14. From this rear side, generally the transport belt is introduced into the frame 13 and the belt connector 2 which is supported therein so that the belt band end 3 is introduced between the legs 5, 6 of the connector elements 4 and moves into abutment against a delimiter element 18 of the connector element 4 in order to avoid introduction of the belt band end 3 into the curved portion 7. Since the receiving region is open laterally, consequently is not delimited, an excessively wide belt band end 3 can also be provided with belt connectors 2. To this end, for example, the frame 13 can be displaced relative to the belt band end 3 so that over the entire longitudinal extent of the belt band end 3 belt connectors 2 can be fitted. In order to ensure an exact orientation relative to the already introduced connector elements 4 in a region, which is not yet provided with belt connectors 2, of the belt band end 3, the bearing rail 16 has additional abutment portions which are provided with abutment contours 19 which correspond to the connector elements 4. Connector elements 4 which are fixed to the belt band end 3 can then already be applied against these abutment contours 19 in order thereby to obtain the same pitch so that, in spite of the belt band end 3 being repositioned, a uniform pitch pattern of connector elements 4 can be achieved.

A plurality of, in this case twelve, identical forming dies 20 which are in the form of separate components are arranged in series in the bearing rail 16, wherein these forming dies 20 are each used to receive two connector elements 4 of the belt connector 2. In FIGS. 23 to 26, such a forming die 20 is illustrated in greater detail. The bearing rail 16 has bearing receiving members 67 which are in the form of recesses and in which the forming dies 20 are inserted from above, wherein the forming dies 20 are positioned with gravitational support on two support rails 36 which are screwed to the bearing rail 16. The bearing receiving members 67 receive the respective forming dies 20 in a positive-locking manner so that the position of the forming die 20 in the longitudinal direction and transverse direction is fixed. In FIG. 20, the bearing rail 16 is provided only with three forming dies 20 for better comprehension. In FIG. 1, however, the bearing rail 16 is completely occupied.

The forming die 20 also has at the upper side thereof an abutment contour 19, wherein this contour corresponds to the outer contour of the connector elements 4 to be received in order to facilitate the positioning of the connector elements 4 of the belt connector 2 and to avoid slippage during fixing. The cooperation of the abutment contour 19 with the connector elements 4 can be seen in FIG. 27. In order to retain the connector elements 4 in positions, the frame 13 further has a retention strip 21, wherein this retention strip 21 forms a stop for the curved portion 7 of the respective connector element 4. Furthermore, the retention strip 21 comprises a plurality of hook-like portions 22, wherein these hook-like portions 22 can be moved into engagement and out of engagement with respect to the connector elements 4 by laterally displacing the retention strip 21, consequently by means of a displacement in the longitudinal direction of the bearing rail 16. If the hook-like portions 22 of the retention strip 21 are engaged with the connector elements 4, the hook-like portions 22 engage behind the respective curved portion 7 of the respective connector element 4 and are consequently used to fix the connector element 4 in the corresponding position. Furthermore, as a result of the hook-like portion 22 of the retention strip 21, the respective connector element 4 is held down so that it cannot be raised off the bearing rail 16 or the forming die 20, respectively. In this regard, the hook-like portion 22 forms a holding-down member. In order to allow displacement of the retention strip 21, the retention strip 21 is screwed to the bearing rail 16, wherein the associated screws are arranged in an elongate hole of the retention strip 21 so that the retention strip 21 can be laterally displaced. The retention strip 21 can thereby be readily moved into engagement with the connector elements 4 of the belt connector 2 and out of engagement therewith.

The frame 13 has two guide rails 23 which are not identical to the bearing rail 16, wherein the tongs-like pressing tool 14 is supported in a displaceable manner along the bearing rail 16 in these guide rails 23. This is made evident by the double-headed arrow 72 in FIG. 20. In specific terms, the frame 13 has a carriage 24 which is supported in the guide rails 23, wherein the pressing tool 14 can be fixed to this carriage 24. The pressing tool 14 can consequently be displaced along the bearing rail 16 and consequently along the belt band end 3 supported at that location with a belt connector 2 arranged thereon.

The pressing tool 14 serves to fix the respective connector element 4 to the belt band end 3 by means of the fixing cramps 9 which are supported in the connector elements 4. To this end, the pressing tool 14 has a multi-piece press-in die 25 and a multi-piece pressing die 26, wherein the bearing rail 16 with the forming dies 20 arranged in the bearing rail 16 is arranged between the dies 25, 26. The press-in die 25 is arranged at an upwardly directed front side of the forming die 20 and the pressing die 26 is arranged at an opposite rear side of the forming die 20 and consequently opposite the press-in die 25. Between the forming die 20 and the press-in die 25, a processing region is formed, wherein in the processing region the connector element 4 to be processed is intended to be arranged with a belt band end 3 arranged between the legs 5, 6 of the connector element 4. In this instance, the processing region of the pressing tool 14 substantially corresponds to the width of two connector elements 4 so that two connector elements 4 can be fixed with two fixing cramps 9 at the belt band end 3 simultaneously by means of the pressing tool 14. After the two connector elements 4 have been fixed, the pressing tool 14 can be displaced relative to two other connector elements 4 which are not yet fixed to the belt band end 3.

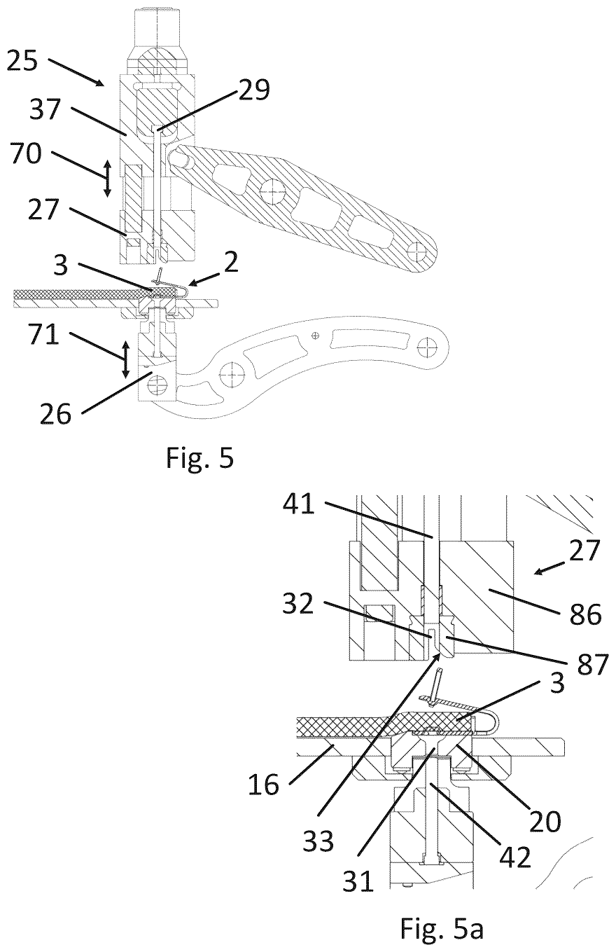

The fixing of the connector elements 4 by means of the pressing tool 14 is illustrated in greater detail in FIGS. 6 to 10 and FIGS. 6a to 10a. The press-in die 25 and the pressing die 26 are linearly displaceable from an initial position into an end position, and vice versa. To this end, the dies 25, 26 are guided in a linear guide 66. The displacement direction of the press-in die 25 is indicated in FIG. 5 by the double-headed arrow 70. The displacement direction of the pressing die 26 is indicated in FIG. 5 by the double-headed arrow 71. By means of the press-in die 25, by displacing the press-in die 25 from the initial position into the end position, the fixing cramp 9 can be driven into the through-holes 8 of the legs 5, 6 so as to penetrate the belt band end 3 which is arranged between the legs 5, 6 of the connector element 4. FIGS. 6 to 8 and FIGS. 6a to 8a show the pressing-in operation.

FIG. 6 shows the pressing tool 14 in an open position, in which the dies 25, 26 are in the initial position. As FIG. 6 shows, the legs 5, 6 of the respective connector element 4 are in the basic state not yet orientated parallel with each other. Accordingly, the through-holes 8 of the legs 5, 6 are also not yet aligned with each other. Therefore, initially, that is to say, before the fixing cramps 9 are driven in by means of the press-in die 25, the connector elements 4 are closed. To this end, a pressing jaw 27 is fitted to the press-in die 25, wherein the pressing jaw 27 is fitted in a leading manner with respect to the press-in die 25 during displacement of the press-in die 25 into the end position, in this regard in the direction of the forming die 20. When the press-in die 25 is displaced in the direction of the end position, the pressing jaw 27 initially moves into abutment against a free end of the first leg 5 of the respective connector element 4 and acts on this leg 5, whereby the first leg 5 is pressed against the belt band end 3 and the connector element 4 is closed. This state is shown in FIG. 7 and FIG. 7a. The pressing jaw 27 has a bearing member 86 and an insert 87 which is inserted in the bearing member 86, wherein the insert 87 is configured in a step-like manner so that the insert 87 in the region of the front edge of the leg 5 acts on the leg 5. The pressing jaw 27 is supported on the press-in die 25 in such a manner that the pressing jaw 27 is linearly displaceable counter to the restoring force of a restoring means 28 which is in the form of a spring relative to the press-in die 25. As a result of the displaceability of the pressing jaw 27 with respect to the press-in die 25, different belt thicknesses and different connector types can reliably be processed. Depending on the belt thickness and/or belt connector 2 used, the restoring means 28 is deflected more or less powerfully.

Following the closure of the connector element 4, the fixing cramps 9 are driven in by means of the press-in die 25. To this end, the press-in die 25 has a multi-piece pressing-in member 29, wherein this pressing-in member 29 acts on the cramp rear 10 of the respective fixing cramp 9 and drives it into the through-holes 8 of the legs 5, 6 so as to penetrate the belt band end 3. The free ends 11, which project at the opposite side, are bent over into an intermediate state during the pressing-in operation on a bending-over structure 30 of the stationary forming die 20. The term “intermediate state” is intended to be understood to mean that the free ends 11 are not yet moved into the final end state thereof, in which they bear on the second leg 6, but are instead slightly pre-bent. This intermediate state is shown in FIG. 8 and FIG. 8a. Furthermore, FIGS. 31 to 33 show the connector element 4 with free ends 11 of the fixing cramp 9 in the intermediate state. The free ends 11 are bent over toward each other during the pressing-in action and in a manner offset relative to each other by an angle a which is approximately 30°. This can be seen in particular in FIG. 31. Since the four fixing cramps 9 are driven in at the same time, the forming die 20 also has four bending-over structures 30. The respective bending-over structure 30 is formed by two mutually overlapping partially spherical recesses, wherein the recesses are offset in different directions with respect to the respective free end 11, as can be seen in FIG. 24. As a result of this offset of the recesses, the respective bending-over structure 30 extends obliquely relative to the cramp rear 10 and accordingly the free ends 11 are also bent over obliquely relative to the cramp rear 10. Accordingly, the bearing pockets 12 are also formed obliquely relative to the cramp rear 10.

The final bending over of the free ends 11 into the end position is carried out by means of the pressing die 26 which is displaceable to this end from the initial position into the end position in the direction of the press-in die 25. In order to allow an action of the pressing die 26 on the free ends 11 of the respective fixing cramp 9, the forming die 20 has four through-openings 31 for the pressing die 26 which extend from the rear side of the die 20 as far as the front side and which open in the respective bending-over structure 30. Accordingly, by displacing the pressing die 26 in the direction of the press-in die 25, the pressing die 26 can act on the pre-bent free ends 11 of the four fixing cramps 9 so as to penetrate through the through-openings 31. By means of the pressing die 26, accordingly the free ends 11 are moved into the end state thereof by these free ends 11 being pressed against the second leg 6 by means of the pressing die 26. FIG. 9 and FIG. 9a show this state with the pressing tool 14 in a closed position. Subsequently, the pressing tool 14 is opened again by the press-in die 25 and the pressing die 26 being displaced from the end position again into the initial position. FIG. 10 and FIG. 10a show this state.

In order to ensure a particularly good guiding of the fixing cramps 9 when driving in the fixing cramp 9 by means of the press-in die 25, the pressing jaw 27 has a slot-like recess 32 which serves to guide the respective fixing cramp 9. This is particularly evident in FIGS. 5a and 12. In order to ensure a clean introduction of the fixing cramp 9 into the respective recess 32, the pressing jaw 27 has a redirecting edge 33 which is formed in an angled manner relative to the displacement direction of the press-in die 25 and which cooperates with the cramp rear 10 of the fixing cramp 9 during displacement of the press-in die 25 in the direction of the end position.

The pressing tool 14 has a support structure 34 in the form of two spaced-apart support elements, wherein the pressing die 26 is formed between the support elements. The support structure 34 serves to support the forming die 20 at the rear side, which faces away from the press-in die 25, of the forming die 20 during the pressing-in operation of the fixing cramp 9 by means of the press-in die 25. However, the forming die 20 moves into abutment against this support structure 34 only in the event of an action of force on the forming die 20, as can particularly be seen in FIGS. 11 and 12. In order to move into abutment against the support structure 34 only in the event of an action of force, the respective forming die 20 has resiliently deformable restoring means 35 with which the forming die 20 is positioned on the support rail 36 which is screwed to the bearing rail 16, as can be seen in particular in FIGS. 11 and 12. In the event of action of force of the pressing jaw 27 on the forming die 20, the forming die 20 moves into abutment against the support structure 34 with resilient deformation of the restoring means 35, whereas without any action of force the forming die 20 is spaced apart from the support structure 34, as can be seen in FIGS. 11 and 12. The broken line 68 between FIG. 11 and FIG. 12 is merely used as an auxiliary orientation member. With corresponding selection of the thickness of the resilient forces of the restoring means 35, accordingly only small forces are transmitted to the bearing rail 16 and the forces which act when the fixing cramp 9 is pressed in are substantially introduced into the pressing tool 14 via the support structure 34

In order to allow an adjustment of the press-in die 25 to different belt thicknesses and/or to different belt connectors 2, the press-in die 25 has a base member 37 in which the pressing-in member 29 which acts on the fixing cramps 9 during the displacement of the press-in die 25 in the direction of the forming die 20 is supported. The pressing-in member 29 projects with respect to the base member 37 in the direction of the forming die 20, wherein the pressing-in member 29 is adjustably supported in the base member 37 in order to change a projection of the pressing-in member 29 with respect to the base member 37. The further the pressing-in member 29 projects with respect to the base member 37, the smaller is the spacing between the pressing-in member 29 and the forming die 20 in the end position of the press-in die 25. For thin belts, accordingly the pressing-in member 29 is adjusted further in the direction of the forming die 20 than for thick belts. The two end positions of the pressing-in member 29 are shown in FIG. 13 and FIG. 14. The broken line 69 between the FIGS. 13 and 14 acts merely as an auxiliary orientation member. In order to adjust the pressing-in member 29, the pressing-in member 29 is linearly guided in the base member 37 and cooperates with a rotatable operating element 38. This rotatable operating element 38 has a thread 39, wherein this thread 39 cooperates with a counter-thread which is formed in the pressing-in member 29. When the operating element 38 is rotated, the thread 39 is rotated and the pressing-in member 29 is displaced in accordance with the thread pitch.

As can be seen in FIGS. 13 and 14, the pressing-in member 29 is not formed in one piece in this instance but instead has a receiving member 40, wherein four pins 41 are inserted in this receiving member 40 for simultaneously pressing in the four fixing cramps 9 of the connector elements 4. The pressing die 25 also has four pins 42 for simultaneously pressing the bent-over free ends 11 of the four fixing cramps 9. Accordingly, the respective forming die 20 also has four bending-over structures 30 and four through-openings 31.

The pressing tool 14 is operated pneumatically in this case, wherein the pressing tool 14 to this end has a pneumatic drive 43 in the form of a pneumatic cylinder for jointly displacing the dies 25, 26. By means of the pneumatic drive 43, an articulation arrangement which is located inside a housing 44 of the pressing tool 14 is driven. In specific terms, the pressing tool 14 has a first articulation arrangement 45 which cooperates with the press-in die 25 and which has articulation members 46, 47 which are pivotable relative to each other and a second articulation arrangement 48 which cooperates with the pressing die 26 and which has articulation members 49, 50 which are pivotable relative to each other. The first articulation arrangement 45 is in the form of a toggle lever in this case. The first and second articulation arrangements 45, 48 are coupled to each other in such a manner that, when the dies 25, 26 are displaced in order to attach the fixing cramp 9, initially the first articulation arrangement 45 reaches a dead center position, wherein in the dead center position the fixing cramp 9 is completely driven in and the free ends 11 are accordingly bent over into the intermediate state. At a chronologically later time relative to the dead center position being reached, the pressing of the free ends 11 is carried out by means of the pressing die 26. To this end, the first lever 49 of the second articulation arrangement 48, which is connected to the first lever 46 of the first articulation arrangement 45, has a free-running contour 51 and a second lever 50 of the second articulation arrangement 48 is displaceably supported in this free-running contour 51 in an articulated manner. The kinematic system of the articulation arrangements 45, 48 is illustrated in FIGS. 17 to 19 which show the movement sequence when closing the pressing tool 14. In the states shown in FIG. 18 and FIG. 19, the first articulation arrangement 45 is in a dead center position.

The pneumatic drive 43 has a piston rod 78 which is connected to the first lever 46 of the first articulation arrangement 45 in an articulated manner, wherein a connection means 52 which connects the drive rod to the lever 46, for example, a connection bolt, is guided in a slotted guiding member 53 which is fixed to a housing along a curved path. As a result of this curved path, the chronologically subsequent pivoting of the second lever 50, which cooperates with the pressing die 25, of the second articulation arrangement 48 is also brought about. The slotted guiding member 53 has a dead center portion which is configured so that, when the dead center portion is travelled, despite the pivoting of the first lever 46 of the first articulation arrangement 45, the first articulation arrangement 45 remains in a dead center position, as can be seen in FIG. 18 and FIG. 19.

The second lever 46 of the first articulation arrangement 45 which is connected to the press-in die 25 is supported in the housing 44 of the pressing tool 14 in a pivotable manner about a first pivot axis 54 which is fixed to the housing and the second lever 50 of the second articulation arrangement 48 which is connected to the pressing die 26 is supported in the housing 44 of the pressing tool 14 in a pivotable manner about a second pivot axis 55 which is fixed to the housing.

The pressing tool 14 is supplied with compressed air via the frame 13, wherein the frame 13 has to this end a compressed air connection 56 in order to connect a compressed air source 81. The compressed air connection 56 is configured in this case in a rear region of the frame 13 so that a compressed air hose to be connected at that location is arranged outside the region required for the operator as far as possible. The compressed air connection 56 is connected to a hose 57 which is guided in the frame 13, wherein this hose 57 is again connected to the carriage 24. The hose 57 is guided in the frame 13 in a loop, wherein this loop is articulated substantially at the center of the bearing rail 16. The frame 13 has profile rails with a groove, wherein the hose 57 is guided at least partially in the grooves of the profile rails. A pneumatically actuatable pneumatic valve 58 is fitted to the carriage 24, that is to say, a 5/2-way pneumatic valve, which is supplied with compressed air via the hose 57. When control air is applied to a control connection 75 of the pneumatic valve 58, the pneumatic valve 58 is moved into a switching position, in which the double-acting pneumatic cylinder of pneumatic drive 43 is acted on with compressed air so that the press-in die 25 and the pressing die 26 are displaced from the initial position into the end position via the articulation arrangement. The pressing tool 14 is accordingly closed.

The control air for switching the pneumatic valve 58 is branched off at a branch 76 and supplied via a connection 80 to a pneumatic control chain which is formed in the pressing tool 14 and which is explained in greater detail below with reference to the pneumatic circuit diagram shown in FIG. 35. In order to switch the pneumatic valve 58, the operator of the pressing tool 14 must operate the pressing tool 14 with both hands, that is to say, press down two buttons 59 which are formed on the handles 15, in order to move a first valve 73 which is in the form of a 3/2-way valve and a second valve 74 which is in the form of a 3/2-way valve into a conducting position so that the control air, which is branched off at a branch 76, can flow through the valves 73, 74. In order to avoid the pressing tool 14 being actuated in an incorrect position, the pressing tool 14 has a third valve 60 with a valve body 61 and a valve piston 62 which is displaceable in the valve body 61 between a first end position and a second end position. The valve piston 62 is resiliently loaded and is located in the basic state in a first end position of the two end positions. In the two end positions of the valve piston 62, actuation of the pneumatic drive 43 is prevented because the third valve 60 is then in a closed position in which no flow of control air to the control connection 75 is possible. Actuation of the pneumatic drive 43 is possible only when the valve piston 62 is in the intermediate position which corresponds to an open position of the third valve 60. By means of this third valve 60, it is ensured that only in positions, corresponding to the forming dies 20, of the pressing tool 14 can actuation of the pneumatic drive 43 and consequently a displacement of the dies 25, 26 be carried out. To this end, a wheel 63 which is connected to the valve piston 62 cooperates with a portion, which is formed along the displacement path, of the bearing rail 16, wherein this portion has a structuring in the form of a hole pattern 64. In the correct positions of the pressing tool 14, the wheel 63 travels into the hole 65 which is associated with this forming die 20, wherein the respective hole 65 is configured in such a manner that the valve piston 62 is located in the state, which is introduced into the hole 65, of the wheel 63 in the intermediate position and accordingly actuation of the pneumatic drive 43 by actuating the push-buttons 59 is possible. This intermediate position is illustrated in greater detail in FIG. 36. In the intermediate position, an inlet channel 82 and an outlet channel 83 of the valve body 61 are connected in fluid terms in this case via a connection channel 84 which is formed in the valve piston 62 and control air can accordingly flow through the valve 60. As a result of the slight offset of the inlet channel 82 relative to the outlet channel 83, a particularly small acceptance range for the intermediate position can be obtained. The structures, designated 85, of the valve piston 62 are grooves 85 for sealing rings which are not illustrated in greater detail.

The first valve 73, the second valve 74 and the third valve 60 are connected in series so that only when all three valves 73, 74, 60 are in the conducting position does the branched-off control air flow to the control connection 74 of the pneumatic valve 58 and switch the pneumatic valve 58 into the conducting position. In the pneumatic circuit diagram illustrated in FIG. 35, the first valve 73, the second valve 74 and the third valve 60 are in a basic state in which the valves 73, 74, 60 are closed. The pneumatic valve 58 is in a switching state in which the double-acting pneumatic cylinder of the pneumatic drive 43 is acted on with compressed air so that the piston rod 78 is retracted so that the dies 25, 26 are in the initial position. If control air is applied to the control connection 74, the switching state of the pneumatic valve 58 is changed and the piston is acted on with compressed air from the other side and the piston rod 78 is extended. The pneumatic drive 43 is consequently actuated. In order to slightly brake the extension of the piston rod 78 during actuation of the pneumatic drive 43, a throttle non-return valve 77 is arranged at a connection at which air is discharged when the piston rod 78 is extended.

The fixing device 1 according to the invention allows a connector element 4 to be fixed in one and the same position of the pressing tool 14 finally to the belt band end 3. Therefore, it is not necessary to change the position of the pressing tool 14 along the belt band end 3 in order to bend over the free ends 11 of the fixing cramp 9 initially into the intermediate state and then to press them against the second leg 6, in this regard to move it into the final end state. The two steps, that is to say, the bending over and the pressing, are consequently carried out in one and the same position of the pressing tool 14. Time can thereby be saved and a particularly good result of the fixing can be achieved.

In the exemplary embodiment illustrated in the Figures, the forming die 20 is configured in a stationary manner, consequently not displaceable in the direction of the free ends 11 in order to bend over the free ends 11. Accordingly, the forming die 20 is arranged so that the free ends 11 are pressed against the bending-over structure 30 of the stationary forming die 20 when the fixing cramp 9 is pressed in by means of the press-in die 25.

In principle, an active displacement of the forming die 20 is also conceivable in order to form the free ends 11. The bending over is not then carried out during the pressing-in action but instead only following the pressing-in action. This is schematically illustrated in FIG. 37 which shows the state after the pressing-in action and before the displacement of the forming die 20 in the direction of the arrow 79. To this end, for example, the forming die 20 can be arranged so as to extend relative to the pressing die 26, similarly to how this can also be carried out with the pressing jaw 27 on the press-in die 25.

That which is claimed is:

1. A fixing device for fixing a belt connector to a belt band end of a transport belt by means of at least one fixing cramp having free ends, wherein the belt connector has at least one connector element having a first leg and a second leg, the fixing device comprising:
a press-in die for pressing in the fixing cramp;
a forming die having a bending-over structure for bending over the free ends of the fixing cramp, which project during the pressing-in of the fixing cramp on the second leg, on the bending-over structure in the direction of the second leg; and
a pressing die which is opposite the press-in die for pressing the free ends of the fixing cramp, which are bent over on the bending-over structure;
wherein the press-in die can be displaced from an initial position into an end position for pressing in the fixing cramp into the first and second legs; wherein the pressing die can be displaced from an initial position into an end position for pressing the bent-over free ends of the fixing cramp at the second leg; and
wherein the forming die has a through-opening for the pressing die.

2. The fixing device according to claim 1, wherein the forming die is stationary and is arranged in such a manner that the free ends of the fixing cramp during pressing-in of the fixing cramp are pressed by means of the press-in die against the bending-over structure of the stationary forming die and are thereby bent over in the direction of the second leg.

3. The fixing device according to claim 1, wherein the displacement of the press-in die from the initial position into the end position is carried out in the direction of the pressing die and the displacement of the pressing die from the initial position into the end position is carried out in the direction of the press-in die.

4. The fixing device according to claim 1, wherein the press-in die has a base member and a pressing-in member which is supported in the base member and which acts on the fixing cramp during the displacement of the press-in die from the initial position into the end position in order to drive in the fixing cramp, wherein the pressing-in member is displaceably supported in the base member in order to change a spacing of the pressing-in member from the forming die in the end position of the press-in die, wherein the press-in die has an operating element which cooperates with the pressing-in member in order to displace the pressing-in member with respect to the base member.

5. The fixing device according to claim 1, wherein the fixing device further has a pressing jaw, wherein the pressing jaw is supported on the press-in die in a leading manner in the direction of the forming die with respect to the press-in die, wherein the pressing jaw acts on the first leg, which faces the press-in die when the press-in die is displaced in order to press the first leg against the belt band end, wherein the pressing jaw is movable counter to a restoring force of a restoring means in the direction of the press-in die.

6. The fixing device according to claim 5, wherein the pressing jaw has a recess for receiving the fixing cramp, wherein during the displacement of the press-in die from the initial position into the end position, the press-in die moves into the recess, wherein the recess forms a linear guide for the fixing cramp when the fixing cramp is pressed in.

7. The fixing device according to claim 6, wherein the pressing jaw has a redirecting edge which is formed at an angle relative to the displacement direction of the press-in die and which acts during the displacement of the press-in die from the initial position into the end position with the fixing cramp in order to introduce the fixing cramp into the recess (32).

8. The fixing device according to claim 1, wherein the press-in die is guided in a linear guide in order to guide the displacement movement of the press-in die from the initial position into the end position and vice versa, and/or wherein the pressing die is guided in the linear guide in order to guide the displacement movement of the pressing die from the initial position into the end position and vice versa.

9. The fixing device according to claim 1, wherein the fixing device further has a first articulation arrangement which cooperates with the press-in die and which has articulation members which can be pivoted relative to each other, wherein the first articulation arrangement is in the form of a toggle lever, and wherein the fixing device further has a second articulation arrangement which cooperates with the pressing die and which has articulation members which can be pivoted relative to each other, wherein the first and second articulation arrangements are coupled to each other so that, when the articulation arrangements are actuated in order to displace the press-in die and the pressing die from the respective initial position into the respective end position, initially the press-in die reaches the end position, wherein the first articulation arrangement in the end position is in a dead center position and, at a subsequent time, the pressing die reaches the end position.

10. The fixing device according to claim 1, wherein the fixing device further has a drive having a piston/cylinder unit and/or has a rotatable shaft having a coupling structure for torque-transmitting connection to a corresponding coupling counter-structure of an external rotary drive.

11. The fixing device according to claim 1, wherein the fixing device further has a frame and a pressing tool, wherein the frame has a bearing rail for supporting the belt band end with a belt connector arranged thereon, wherein a plurality of the forming dies are formed or arranged in the bearing rail along a longitudinal extent of the bearing rail, wherein the pressing tool has the press-in die and the pressing die, wherein the frame has a guide rail, wherein the pressing tool is supported in the guide rail in a displaceable manner along the bearing rail and consequently along the belt band end.

12. The Fixing device according to claim 11, wherein the plurality of the forming dies are in the form of separate components, wherein the bearing rail has bearing receiving members, wherein the plurality of the forming dies are supported in the bearing receiving members, wherein the bearing receiving members have through-openings for the pressing die at least in the region of the through-openings of the plurality of the forming dies.

13. The fixing device according to claim 12, wherein the pressing tool has a support structure for supporting a respective forming die on a side, which faces away from the press-in die, of the forming die during the operation of pressing in the fixing cramp by means of the press-in die, wherein the respective forming die is supported on a resiliently deformable restoring means in the bearing rail so that, when the press-in die applies force to the forming die, the forming die moves into abutment against the support structure with the restoring means being deformed, and, without any application of force by the press-in die to the forming die, the forming die is spaced apart from the support structure.

14. The fixing device according to claim 12, wherein the pressing tool has a pneumatic drive for displacing the press-in die and the pressing die, wherein the pressing tool comprises a mechanically actuatable valve having a valve body and a valve piston which is displaceable in the valve body between a first end position and a second end position, wherein in both the first and second end positions of the valve piston actuation of the pneumatic drive in order to displace the press-in die and the pressing die into the first and second end positions is prevented and, in the intermediate position between the first and second end positions, actuation of the pneumatic drive is possible, wherein, during displacement of the pressing tool in the frame, the valve piston cooperates with a portion, which is formed along the displacement path, of the frame, wherein the portion has a structuring, wherein the structuring is configured in such a manner that the valve piston is in the intermediate position only in pressing-in positions of the pressing tool in which the pressing die can move into the through-opening of the forming die.

15. A method for fixing a belt connector to a belt band end using the fixing device according to claim 1, the method comprising:
a) arranging a connector element of the belt connector with a belt band end which is arranged between the first and second legs of the connector element between the press-in die and the forming die;
b) pressing in the at least one fixing cramp so as to penetrate the belt band end which is arranged between the first and second legs of the connector element by displacing the press-in die from the initial position into the end position;
c) bending over the projecting free ends of the fixing cramp on the bending-over structure of the forming die in the direction of the second leg;
d) pressing the bent-over free ends of the fixing cramp against the second leg by displacing the pressing die from the initial position into the end position;
wherein pressing the bent-over free ends of the fixing cramp is carried out chronologically after bending over the projecting free ends of the fixing cramp, and
wherein pressing in the at least one fixing cramp, bending over the projecting free ends of the fixing cramp and pressing the bent-over free ends of the fixing cramp are carried out in one and the same position of the fixing device with respect to the connector element.
